(19) United States
(12) Patent Application Publication
(10) Pub. No.: US 2019/0166301 A1
(43) Pub. Date: May 30, 2019

(54) MUTUAL-OPERABLE PHOTO-CAPTURING SYSTEM

(71) Applicant: SPEED 3D Inc., Taipei City (TW)

(72) Inventors: Shiann-Tsong Tsai, Taipei City (TW); Li-Chuan Chiu, Taipei City (TW); Wei-Meen Liao, Taipei City (TW)

(21) Appl. No.: 15/856,082

(22) Filed: Dec. 28, 2017

(30) Foreign Application Priority Data
Nov. 27, 2017 (CN) 201711208923.6

(51) Int. Cl. H04N 5/232; G06T 11/60

(52) U.S. Cl. CPC H04N 5/23206; G06T 11/60; H04M 1/0264; H04N 5/23293; H04N 5/23216

(57) ABSTRACT

A mutual-operable photo-capturing system includes a mobile device and an electronic device. The mobile device includes a processing module, a display module, a communication module, a first storage module, and a first image-capturing module. The mobile device stores an application program. The electronic device includes a control module, a transmission module, a second storage module, and a second image-capturing module. The second image-capturing module includes a camera lens, and the electronic device sores the application program. The mobile device is adapted to be signally connected to the electronic device through an internet. The mobile device and the electronic device execute the application program. The mobile device operates the second image-capturing module by executing the application program. The display module displays an augmented reality frame captured by the camera lens of the second image-capturing module.

### BACKGROUND OF THE INVENTION

### 1. Field of the Invention

The present invention relates to a mutual-operable photo-capturing system, in particular to a mutual-controllable photo-capturing system.

### 2. Description of the Prior Art

Nowadays people like to use convenient selfie function of an electronic device, for example, a smart phone, to take pictures. However, due to the intrinsic physiological limitation, a user cannot allow the camera lens of the electronic device to cover the full-scene and take a full-scene selfie photo by just using his or her arms. Accordingly, a tool for selfie purposes is developed, like a selfie stick. However, when a user uses the selfie stick to take a selfie photo, he or she cannot adjust the lens or focus accurately. Furthermore, the user can check the photo after the selfie is finished. When the focusing, the aperture, or the position of the cameras is not proper, the user has to take the photo again.

### SUMMARY OF THE INVENTION

In view of these problems, an embodiment of the present invention provides a mutual-operable photo-capturing system. The system comprises a mobile device and an electronic device. The mobile device comprises a processing module, a display module, a communication module, a first storage module, and a first image-capturing module. The mobile device stores an application program. The electronic device comprises a control module, a transmission module, a second storage module, and a second image-capturing module. The second image-capturing module comprises a camera lens, and the electronic device sores the application program. The mobile device is adapted to be signally connected to the electronic device through an internet. The mobile device and the electronic device execute the application program. The mobile device operates the second image-capturing module by executing the application program. The display module displays an augmented reality frame captured by the camera lens of the second image-capturing module.

Accordingly, based on embodiments of the mutual-operable photo-capturing system, both the mobile device and the electronic device are installed with the same application program. Therefore, through the application program, the mobile device can operate the second image-capturing module of the electronic device and the electronic device can operate the first image-capturing module of the mobile device. Hence, the photos captured by the second image-capturing module can be displayed on the mobile phone and the photos captured by the first image-capturing module can be displayed on the electronic device. The mobile device can set parameters, such as shutter, filter, aperture, and flashlight, of the second image-capturing module by executing the application program.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic view of a mutual-operable photo-capturing system according to an exemplary embodiment of the present invention;

FIG. 2 illustrates a schematic view of a mutual-operable photo-capturing system according to another embodiment of the present invention; and

FIG. 3 illustrates an operational schematic view of a mutual-operable photo-capturing system according to an exemplary embodiment of the present invention.

### DETAILED DESCRIPTION

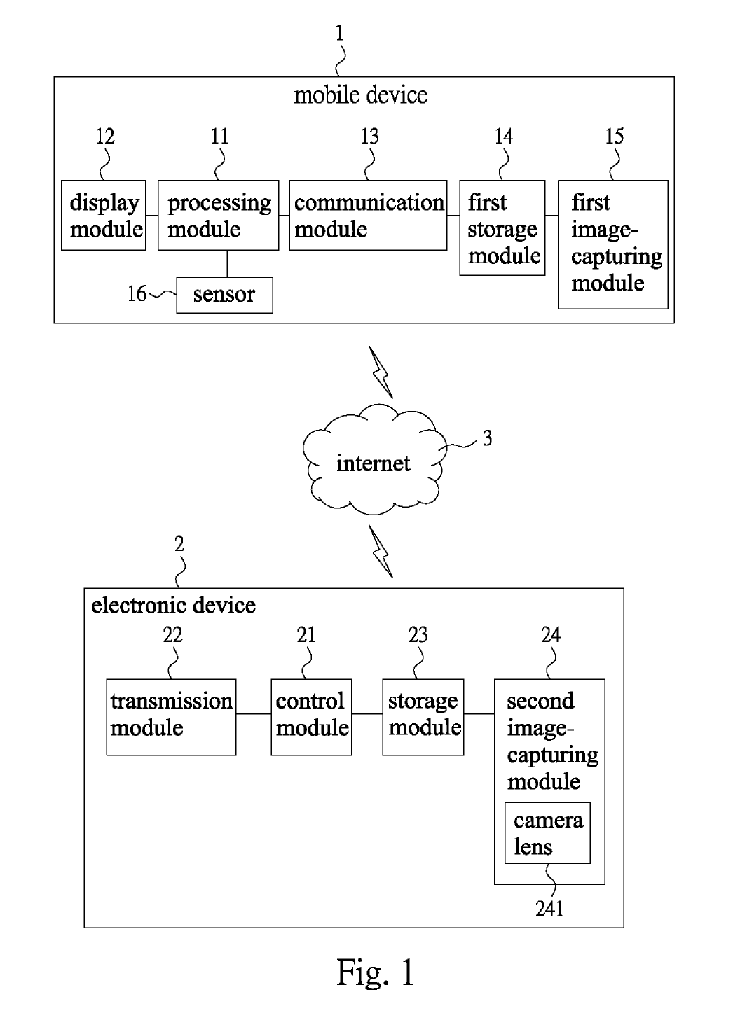

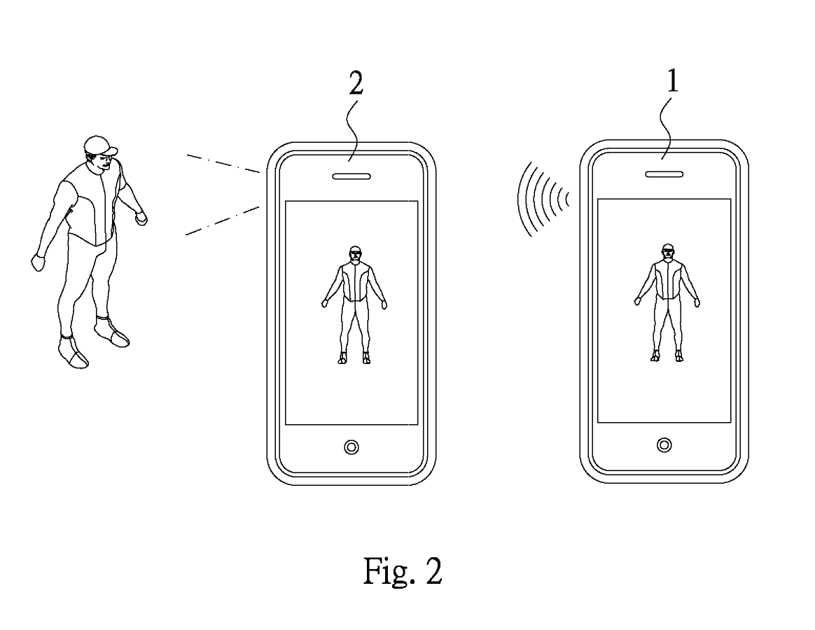

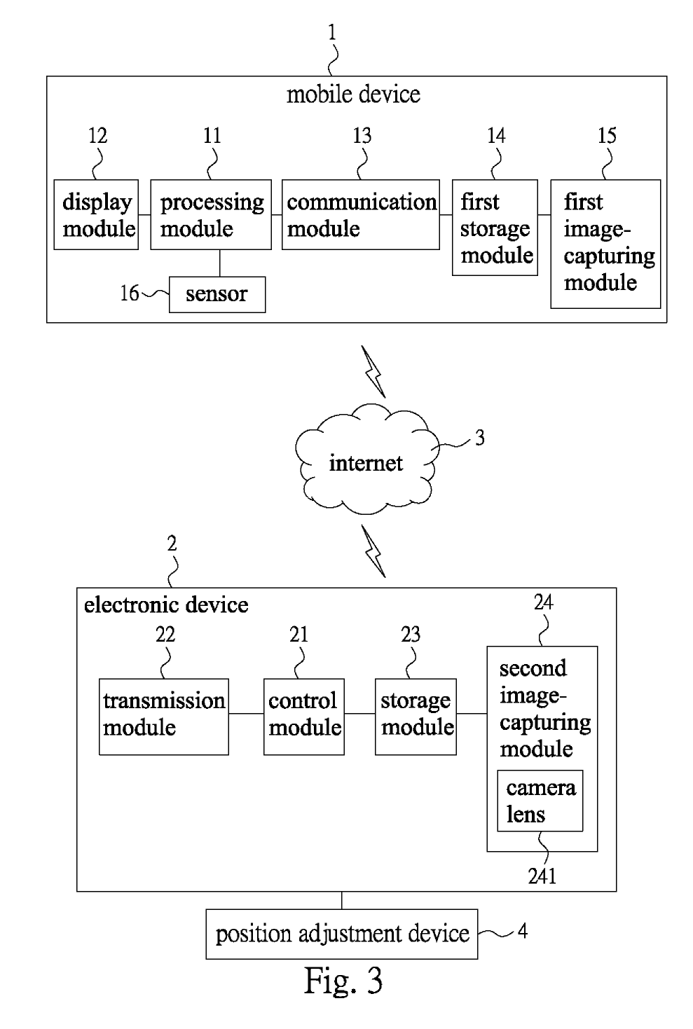

Please refer to FIGS. 1 to 3, respectively illustrating schematic and operational views of a mutual-operable photo-capturing system according to embodiments of the present invention. The mutual-operable photo-capturing system comprises a mobile device 1 and an electronic device 2. The mobile device 1 may be a tablet computer or a smart phone. The electronic device 2 may be a tablet computer or a smart phone as well. The mobile device 1 comprises a processing module 11, a display module 12, a communication module 13, a first storage module 14, and a first image-capturing module 15. The mobile device 1 stores an application program. The electronic device 2 comprises a control module 21, a transmission module 22, a second storage module 23, and a second image-capturing module 24. The second image-capturing module 24 comprises a camera lens 241. The electronic device 2 stores the application program. The mobile device 1 is adapted to be signally connected to the electronic device 2 through an internet 3. The mobile device 1 and the electronic device 2 execute the application program. The mobile device 1 operates the second image-capturing module 24 by executing the application program. The display module 12 plays an augmented reality frame (AR frame) captured by the camera lens 241. In other words, when the mobile device 1 and the electronic device 2 both execute the application program, the mobile device 1 and the electronic device 2 can be signally connected with each other through the internet 3. Therefore, the mobile device 1 can operate the second image-capturing module 24 of the electronic device 2 and perform a remote display to achieve the selfie purpose.

The way to use the mobile device 1 to operate the electronic device 2 is described as below.

In one embodiment, the mutual-operable photo-capturing system further comprises a sensor 16 connected to the processing module 11. The sensor 16 senses an image parameter of the AR frame to enhance an effect of the AR frame. For example, the image parameter is the depth of field (DOF). The sensor 16 senses the depth of the AR frame to adjust the AR frame. In one embodiment, the mobile device 1 executes the application program and configures a virtual object in the AR frame. For example, the AR frame may be a model, and the virtual object is a cloth. The display module 12 (e.g., a display) of the mobile device 1 may receive the image (i.e., the model) captured by the camera lens 241 of the second image-capturing module 24 . Therefore, a visual effect showing that the model wears the cloth can be displayed. Moreover, the sensor 16 can adjust the frame properly according to the image parameter such as the DOF or other dynamic information, to enhance the AR frame. Accordingly, the user can use the mobile device 1 to adjust the position of the camera lens 241 of the second image-capturing module 24, combine and interact the virtual objects with the AR frame, and store or record the combination and the interaction. It is understood that, the electronic device 2 operated by the mobile device 1 can receive the frame displayed on the mobile device 1, and if the electronic device 2 has a display, the frame displayed on the mobile device 1 may be also displayed on the display of the electronic device 2. The sensor 16 may be built in the mobile device 1 or externally connected to the mobile device 1, and the sensor 16 may be a motion sensor or an optical sensor. The sensor 16 can detects the image parameter of the AR frame captured by the camera lens 241 of the second image-capturing module 24 and transmit a corresponding data to the processing module 11. Hence, the processing module 11 analyzes and calculates the data to further enhance the AR frame displayed on the display module 12.

In one embodiment, the mutual-operable photo-capturing system comprises a plurality of electronic devices 2 adapted to capture a frame with different angles. The mobile device 1 has the sensor 16 to receive the AR frames captured by the electronic devices 2 at different angles to transmit image-parameters corresponding to the AR frames to the processing module 11. Hence, the processing module 11 analyzes and calculates the data to display the integrated AR frame. For example, a first electronic device 2 captures an image of a front portion of a model, and a second electronic device 2 captures an image of a rear portion of the model. Then, the processed AR frames can be displayed on the mobile device 1. Accordingly, the user can realize a visual effect showing that the model wears the cloth from different aspects. In some embodiments, the object may be furniture, and the AR frame is the interior of a house. Therefore, the user can use the mobile device 1 to remote control the electronic devices 2 and captures the interior of the house. Hence, the furniture can be displayed in the spaces of the interior of the house, and the displayed frame can be recorded or stored.

In one embodiment, the mutual-operable photo-capturing system further comprises a position adjustment device 4. The position adjustment device 4 may be a rotatable holder, a retractable tripod, or a tripod with rotate and retract functions. The position adjustment device 4 comprises a signal receiver. When the user assembles the electronic device 2 on the position adjustment device 4, the mobile device 1 transmits a signal to the position adjustment device 4 by executing the application program. Then, the position adjustment device 4 receives the signal and moves according to the signal. Accordingly, the mobile device 1 can operate the position adjustment device 4 in a convenient manner.

In one embodiment, the position adjustment device 4 adjusts the position of the electronic device 2 according to a height signal, a rotation signal, or a movement signal. In other words, since the electronic device 2 is assembled on the position adjustment device 4, when the position adjustment device 4 is rotated, moved in a vertical direction, or moved in a horizontal direction, the position of the electronic device 2 is changed along with the motions of the position adjustment device 4. Therefore, the user can place the camera lens 241 of the second image-capturing module 24 of the electronic device 2 to a proper position.

In one embodiment, the position adjustment device 4 adjusts a position of the camera lens 241 of the electronic device 2 toward the mobile device 1 for transmitting a signal in advance.

In one embodiment, the mobile device 1 executes the application program to operate the second image-capturing module 24 to set at least one of aperture, shutter, and color. Alternatively, the mobile device 1 executes the application program to operate the second image-capturing module 24 to further set the focal length, the wide-angle parameter or other data of the second image-capturing module 24.

In one embodiment, the mobile device 1 executes the application program to operate the second image-capturing module 24 to set a photo-capturing timing. In other words, the user may set a predefined photo-capturing timing, like five or ten seconds. Hence, after the predefined photo-capturing time goes by, the second image-capturing module 24 executes the photo-capturing or video-recording function.

In one embodiment, the mobile device 1 operates the second image-capturing module 24 to take a shot to generate a photo, and the mobile device 1 further stores the image in at least one of the first storage module 14 and the second storage module 23. In other words, the user can store the captured photo in the first storage module 14 of the mobile device 1 or in the second storage module 23 of the electronic device 2. In one embodiment, the mobile device 1 receives the captured photo of the electronic device 2 through the internet 3.

In one embodiment, the mobile device operates the second image-capturing module to take a shot to generate a photo, and the mobile device further transmits the photo to asocial-network platform. The social-network platform may be Facebook, Weibo, or Instagram.

In one embodiment, the mobile device 1 operates the second image-capturing module 24 to take a shot to generate a photo, and the application program automatically perform an embellish step to the photo. In other words, the application program analyzes the photo captured by the user and applies an embellish process to the photo, such as improving the lighting or removing the noises. Therefore, the photo can be embellished to have a better visual feeling.

Those skilled in the art will readily observe that numerous modifications and alterations of the device and method may be made while retaining the teachings of the invention. Accordingly, the above disclosure should be construed as limited only by the metes and bounds of the appended claims.

1. A mutual-operable photo-capturing system, comprising:
a mobile device comprising a processing module, a display module, a communication module, a first storage module, and a first image-capturing module, wherein the mobile device stores an application program; and
an electronic device comprising a control module, a transmission module, a second storage module, and a second image-capturing module, wherein the second image-capturing module comprises a camera lens, and the electronic device stores the application program;
wherein, the mobile device is adapted to be signally connected to the electronic device through an internet, the mobile device and the electronic device execute the application program, the mobile device operates the second image-capturing module by executing the application program, the display module displays an augmented reality frame captured by the camera lens of the second image-capturing module; and the mobile device is installed with a first application program, the electronic device is installed with a second application program associated with the first application program, so that through the first and second application programs, the mobile device operates the second image-capturing module of the electronic device and the electronic device operates the first image-capturing module of the mobile device.

2. The photo-capturing system according to claim 1, further a sensor connected to the processing module, the sensor senses an image parameter of the augmented reality frame to enhance an effect of the augmented reality frame.

3. The photo-capturing system according to claim 1, further comprising a position adjustment device, the position adjustment device comprises a signal receiver, the electronic device is assembled on the position adjustment device, the mobile device operates the position adjustment device by executing the application program.

4. The photo-capturing system according to claim 3, wherein the mobile device transmits at least one of a height signal, a rotation signal, and a movement signal to the position adjustment device to adjust a position of the electronic device.

5. The photo-capturing system according to claim 3, wherein the position adjustment device adjusts a position of the camera lens of the electronic device toward the mobile device in advance for transmitting a signal.

6. The photo-capturing system according to claim 1, wherein the mobile device executes the application program to operate the second image-capturing module to set at least one of aperture, shutter, and color.

7. The photo-capturing system according to claim 1, wherein the mobile device executes the application program to operate the second image-capturing module to set a photo-capturing timing.

8. The photo-capturing system according to claim 1, wherein the mobile device operates the second image-capturing module to take a shot to generate a photo, and the mobile device further stores the photo in at least one of the first storage module and the second storage module.

9. The photo-capturing system according to claim 1, wherein the mobile device operates the second image-capturing module to take a shot to generate a photo, and the mobile device further transmits the photo to a social-network platform.

10. The photo-capturing system according to claim 1, wherein the mobile device operates the second image-capturing module to take a shot to generate a photo, and the application program automatically perform an embellish step to the photo.
